(19) United States
(12) Patent Application Publication
(10) Pub. No.: US 2025/0072403 A1
(43) Pub. Date: Mar. 6, 2025

(54) Squidgly

(71) Applicant: Ariel Ramon, JR., Miami, FL (US)

(72) Inventor: Ariel Ramon, JR., Miami, FL (US)

(21) Appl. No.: 18/239,754

(22) Filed: Aug. 30, 2023

(51) Int. Cl. A01K 61/20

(52) U.S. Cl. CPC A01K 61/20; A01K 63/006

(57) ABSTRACT

Squidgly is a versatile tool for marine biology facilities, coral aquascaping and reef hobbyists. Designed to reduce hand and water contact while being an extension of your hand. Tool is a shaft available in different lengths. One side of the shaft includes a handle with a spring pulling mechanism. The other side of the shaft includes a unique detachable pair of claws/grabber. Handle and claws are internally connected in the shaft with a quick release design. Claws have an open resting position that will close and grab when the user pulls the handle mechanism. Each claw's shape and length is unique for the sole purpose of the design, but they are detachable, rotate 360°, snap and lock into 45°, 90°, and 180°. Using this tool will limit hand and water contact therefore reducing contaminants in the water, resulting in healthier corals, fish and clean water.

Squidgly is a versatile extended grabber for marine biology facilities, coral aquascaping and reef hobbyists. Designed for coral and small marine life handling.

Tool is a reef Safe PVC shaft available in different lengths. One side of the shaft includes a (Handle with a spring compression mechanism).

The handle is made from a reef safe 3D printed plastic and two stainless steel springs. This side will be where you hold, control and maneuver the grabber from.

The other side of the shaft includes a unique detachable pair of claws. Claws are made from a reef safe 3D printed plastic and internally include a stainless steel spring.
Handle and claws are connected inside the shaft with a quick release design including a plastic coated stainless steel wire with a cable end stop.

Claws have an open resting position, held with a spring that will compress resulting in the claws to close and grab the coral when the user pulls the handle's mechanism. Each claw's shape and length is unique for the sole purpose of the design and function; short claws are for tight spaces and angles, while longer claws are for harder to reach areas in or around corals, but they are all detachable, rotate 360°, snap and lock into 45°, 90°, and 180°.

Example: Coral in an aquarium is knocked over by a fish or natural occurrence, the coral lands on another nearby coral causing “coral warfare”: corals to die. Using this tool users can easily reach and grab the corals using the best claw design depending on the best angled approach and the type of handling the coral requires.

Without this tool: Normally the user will submerge arms and hands inside aquarium water, due to the fact that there is no other grabber designed to rotate 360°, snap and lock into 45°, 90°, and 180° and handle the coral safely without harming the animals.

Benefits: Squidgly tool will limit hand and water contact therefore reducing contaminants in the water such as hand soap, body lotion and harmful deodorants; resulting in healthier corals, fish and most important clean water.

The invention claimed is:

1. A marine apparatus consisting of:
A shaft member having a frontal and rear portion;
A handle removably secured to the frontal portion of the shaft;
and claw members removably secured to the rear portion of the shaft.

2. A marine apparatus as in claim 1, wherein the claws can rotate 360 degrees.

3. A marine apparatus as in claim 1, wherein the claws can fold 45, 90, 180 degrees.

4. A marine apparatus as in claim 1, wherein the claws and handle are secured to each other with respect to the shaft member.

5. A marine apparatus as in claim 1, wherein the claws and handle are made of 3D printing plastic with respect to the shaft member.

6. A marine apparatus as in claim 1, wherein the shafts are made of PVC with respect to the Claws and Handle members.
